(19) United States
(12) Patent Application Publication
(10) Pub. No.: US 2006/0283664 A1
(43) Pub. Date: Dec. 21, 2006

(54) Extension ladder apparatus

(76) Inventor: Kuo-Ching Yao, Lu-chou City (TW)

Correspondence Address: LOWE HAUPTMAN BERNER, LLP, 1700 DIAGONAL ROAD, SUITE 300, ALEXANDRIA, VA, 22314, US

(21) Appl. No.: 11/154,599

(22) Filed: Jun. 17, 2005

(51) Int. Cl. E06C 1/00

(52) U.S. Cl. 182/156

(57) ABSTRACT

An extension ladder apparatus comprises a plurality of ladder sections, transverse step portions, and locking mechanism, wherein each ladder section is composed of hollow rungs, end caps, and connection kits; the caliber of each hollow rung becomes smaller when the hollow rung is in a relatively high location, which allows the hollow rung to extend and extract to fit each other; a horizontally positioned locking mechanism is connected with the connection kit of said ladder section; wherein said end caps, hollow rungs, and connection kits are stuck in place and then fastened, while connection kits are wrapped by transverse step portions to prevent rust damage, which improves appliance safety and prolongs ladder life.

### BACKGROUND OF THE INVENTION

1. Field of the Invention

The present invention relates to an extension ladder, and more particularly to an extension ladder apparatus, which can be assembled easily and securely and provides superior safety.

2. Description of the Prior Art

Accordingly, stepladders have become a requisite tool for casual use. For example, climbing tools such as a ladder or scaffolding enable people to readily process construction or obtain the objects at a high place.

A conventional stepladder 800, as shown in FIG. 1, is assembled by two ladder sections having a footpad respectively to prevent slippage, and is provided with parallel spaced step portions therein. The stepladder appears as an A-frame ladder during usage.

Stepladders are typically large and bulky; therefore, it is uneasy and inconvenient to carry them. Moreover, the storage of a folded stepladder may occupy large space, which makes the use of a stepladder inflexible.

Accordingly, the present invention has been invented to solve the above-mentioned problems occurred in the prior art.

### SUMMARY OF THE INVENTION

Accordingly, an object of the present invention is to provide an extension ladder apparatus, which is composed of multi-segment ladder sections, transverse step portions, and locking mechanism. Each ladder section is composed of hollow rungs, end caps, and connection kits, providing an easy and convenient way to fold and take along, store, or unfold and use.

In the extension ladder apparatus according to the present invention, the end caps, hollow rungs, and connection kits are stuck in place and fastened. This prevents these components from loose and disattachment, which serves as another object of the present invention.

In the extension ladder apparatus according to the present invention, the connection kits are wrapped by transverse step portions to provide against rust and damage, which serves as further object of the present invention.

The detailed structure, application principle, function, and effects of the present invention will be more apparent from the following descriptions taken in conjunction with the accompanying drawings.

### BRIEF DESCRIPTION OF THE DRAWINGS

FIG. 1 is a three-dimensional view of a conventional extension ladder;

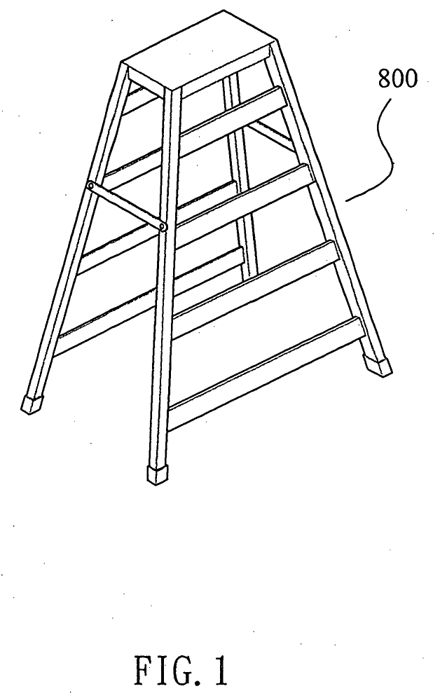

FIG. 2 is a three-dimensional view of the present invention;

FIG. 3 is a three-dimensional view showing the folding and unfolding of the push rod in the present invention;

FIG. 4 is a three-dimensional exploded view showing the ladder section and transverse step portion in the present invention;

FIG. 5A is a three-dimensional assembly view showing the section and transverse step portion in the present invention;

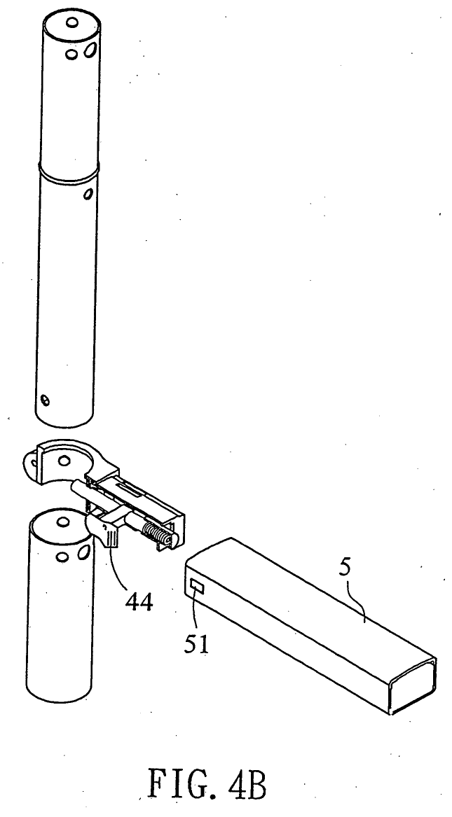

FIG. 5B is a three-dimensional exploded view showing an another example of the present invention;

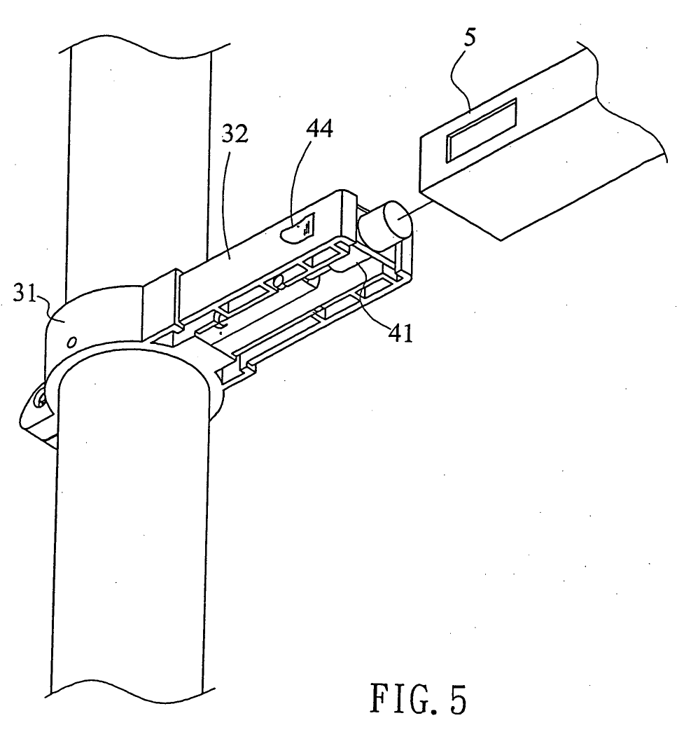

FIG. 6 is a sectional view showing the assembly of the section and transverse step portion in the present invention;

FIG. 7 is a sectional view of the embodiment in the present invention.

### DETAILED DESCRIPTION OF THE EMBODIMENTS

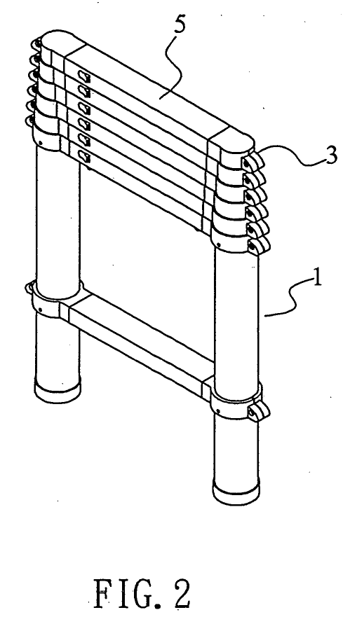

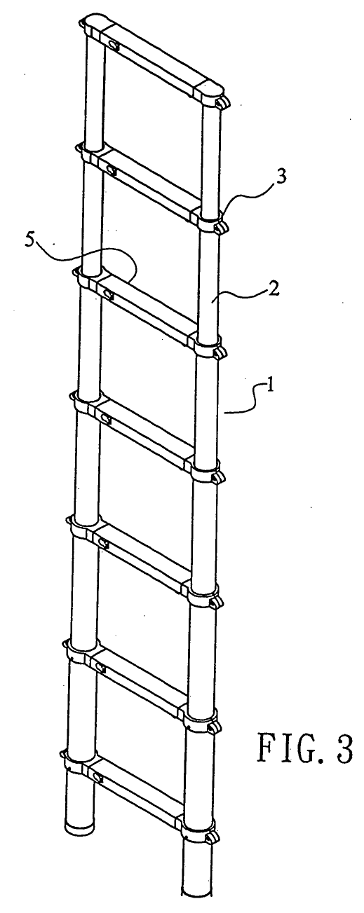

The extension ladder apparatus according to the present invention, in which the extension ladder 1 can be folded (as shown in FIG. 2) or unfolded (as shown in FIG. 3), comprises a plurality of ladder sections 2, transverse step portions 3, and locking mechanism 4. The stepladder appears as a longitudinally extended ladder when it is unfolded and in use, and can be folded by fitting the ladder sections having different calibers one another.

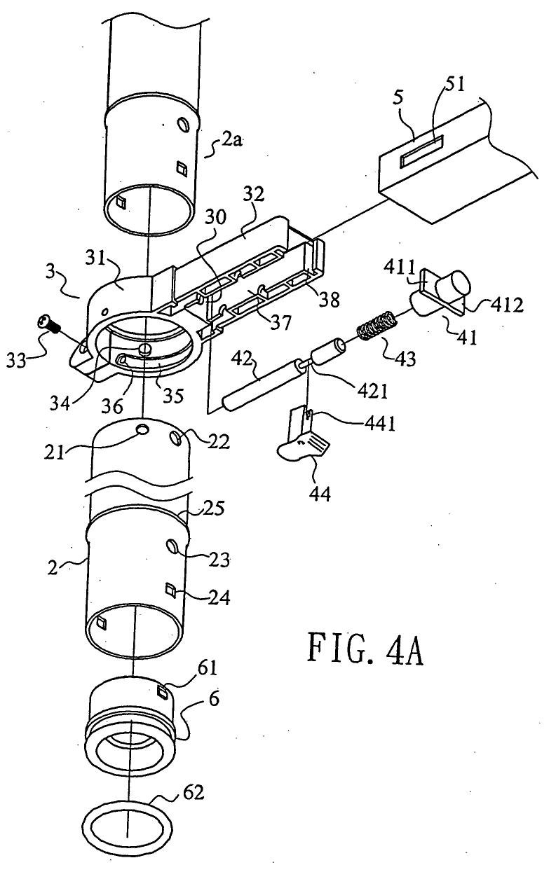

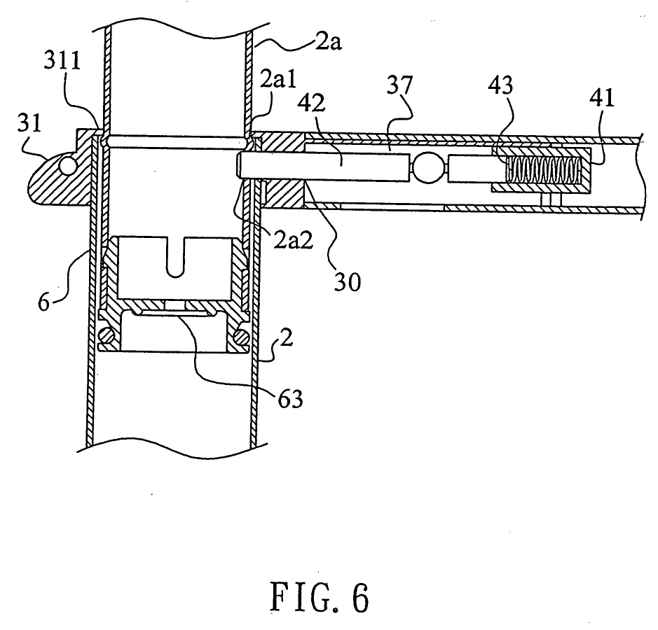

As shown in FIGS. 4 5A and 5B, the ladder section 2 comprises a hollow rung 21, an end cap 22, and a connection kit 23. The caliber of each hollow rung 21 becomes smaller when a rung is in a relatively high location. On the upper end of said hollow rung, a ring like concaved portion 211, a hemispheric tenon 212, and a hole 213 are formed; on the lower end of said hollow rung, a through hole 214 is provided. The upper end of each hollow rung 21 is covered with a ring-shaped end cap 22, and the external part of the end cap is covered with a connection kit 23. Also, an inwardly protruding ring 221, a protrusion 222, and an expansion joint 223 on the end cap are provided in the position relative to the ring-like concaved portion 211 on the hollow rung 21, hemispheric tenon 212, and hole 213 respectively. The bottom of said end cap is provided with a outwardly protruding outer rim 224. In addition, adhesive channels 225 and 226 are provided on the surface of outside wall and inside wall of said end cap. The adhesive channels 225 and 226 are interlinked to each other through a via hole 227. Furthermore, an inwardly protruding inner rim 228 is provided on the top of said end cap 22 (as shown in FIG. 6).

Said connection kit 23 has a sleeve 231 for covering said end cap and two parallel junction plates 232 provided in the direction of said sleeve's caliber. The wall of said sleeve 231 is provided with a hole 233 for infusing the adhesive therein. Also, a snap-fit hole 234 is provided on the outside of sleeve in the position between two junction plates 232.

The locking mechanism 4, as shown in the figure, includes a locking gear 41, a locking bar 42, a spring 43, and a turning rod 44; two front ends of said locking gear 41 are provided with hooked-shaped tips 411 for clasping the junction plate 232 of said connection kit. In the internal back end of said locking mechanism, a chamber for loading a spring 43 is provided, so that one end of locking bar 42 is against said spring 43 and the other end of locking bar 42 faces snap-fit hole 234 of the connection kit. In the locking bar, after a turning rod 44 is inserted into the axle center 421 in the middle of said locking bar 42, said turning rod 44 can be twisted, so that the pivot pin 441 on the upper end of turning rod 44 is snap-fit into the predetermined groove 412 of the locking gear. Accordingly, the locking bar can be rotated by using the pivot pin 441 as axle center.

Said transverse step portion 3, is provided on the external part of said locking mechanism 4, with a clearance hole 31 formed on its upper surface end for the turning rod 44 to extend outwardly, and on its lower surfaceee, there is a timble 30 outwardly extended.

Additionally, the lower end of hollow rung 21 is provided with a sleeve-shaped buffering device 5, with its upper end hooked and affixed in the pre-determined opening 52 by means of a hooked-shaped portion 51, and the outside of its lower end provided with an elastic seal ring 53 for maintaining friction when it contacts the internal part of said rung, and reducing noise and slowing down the folding. As shown in FIG. 6, a mylar 54 is provided in the internal part of said hollow rung with its surface having a hole. Therefore, airs can pass in and out via the hole when the rungs move upwards and downwards, which enhances the cushioning effect.

When assembling has been completed, as shown in the figure, a buffering device 5 and an elastic seal ring 53 are provided in the lower end of the hollow rung to enhance the friction between the hollow rung and the inner wall of said rung, so that the hollow rung can fall downward slowly. Also, the end cap 22 in the upper end of said rung is provided with adhesive channels 225 and 226 for infusing the adhesive, so that the end cap, hollow rung 22, and connection kit 23 can be adhered to each other. Accordingly, the present extension ladder is assembled integrally and securely. Moreover, the provided locking mechanism 4 is fully covered within the internal part of the transverse step portion 3, which not only makes it easy and convenient to control the locking mechanism, but also prevents the damage caused by any foreign object.

When the stepladder is extended for use, the through hole 214 in the lower part of inner hollow rung is affixed in place by passing the locking bar 42 in the outside of said hollow rung therethrough. When said locking bar 42 is drawn out, the inner hollow rung will descend and fold automatically.

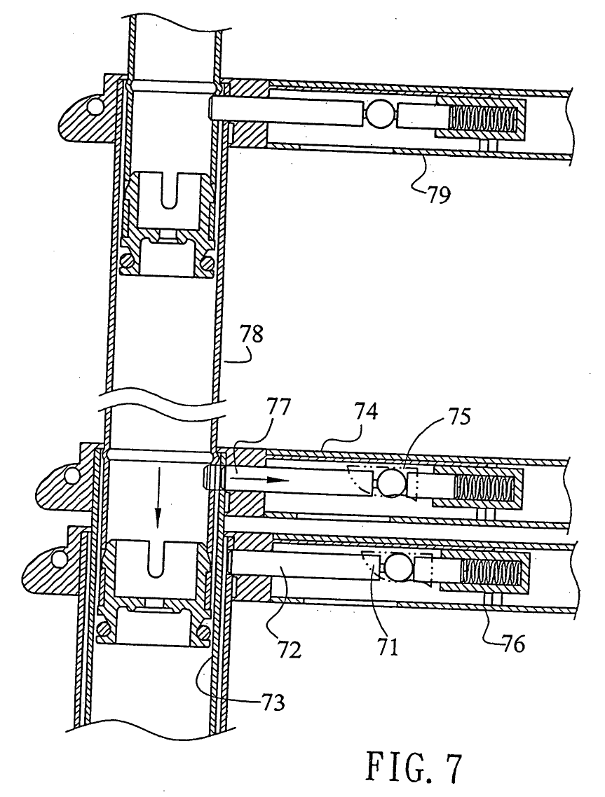

In the following description and drawings, different reference numerals are used to designate different components. When a stepladder is folded, as shown in FIG. 7, When the upper step portion 64 moves downward, its timble 64 shall extend through a via hole of lower step portion 61 to push the turning rod 63 inside the lower step portion 61 to rotate and force the locking bar 63 to withdraw from the snap-fit hole and through hole of the second rung section; then, second rung section 64 along with the second transverse step portion 65 falls downward due to a lack of the obstruction. The second transverse step portion 64 falls downward until its turning is forced to rotate clockwise, driving the inner locking bar 67 to withdraw from the snap-fit hole, which makes the third rung section and third step portion fall down smoothly. On the analogy of this, all rung sections and step portions can be folded quickly.

As described above, the extension ladder apparatus in the present invention certainly enhances appliance safety, and makes folding and using quick and convenient, which can improve the deficiencies of conventional ladders. Also, the present invention has not yet opened to public, it is then complied with the conditions of allowable patents.

Although the above-mentioned embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. An extension ladder apparatus, comprising:
a plurality of ladder sections, transverse step portions, and locking mechanism; the extension ladder is characterized in that: said ladder sections are composed of a plurality of hollow rung with different calibre and connected with each other; the top of each hollow rung is provided with an end cap and connection kit, while one end of said connection kit is provided with a locking mechanism and transverse step portion.

2. The extension ladder apparatus as claimed in claim 1, wherein said end caps, hollow rungs, and connection kits are stuck in place and connected with each other.

3. The extension ladder apparatus as claimed in claim 1, wherein an adhesive channel is provided in the inside wall and outside wall of said end caps for pouring the adhesive, so that the hollow rung and connection kits are cohered.

4. The extension ladder apparatus as claimed in claim 1, wherein the internal and external adhesive channels of said end caps are connected with each other.

5. The extension ladder apparatus as claimed in claim 1, wherein a ring like concaved portion is formed in the partial segment of top of said rung, which is engaged with the inwardly protruding ring in the position relative to said end cap.

6. The extension ladder apparatus as claimed in claim 1, wherein a hemispheric tenon is formed in the partial segment of the top of said rung, which is engaged with the hole provided in the position relative to said end cap.

7. The extension ladder apparatus as claimed in claim 1, wherein said end cap is provided in an expansion joint.

8. The extension ladder apparatus as claimed in claim 1, wherein said connection kit has a sleeve for covering said end cap and two parallel junction plates provided in the direction of said sleeve's caliber; a snap-fit hole is provided on the outside of said sleeve in the position between two parallel junction plates.

9. The extension ladder apparatus as claimed in claim 1, wherein said locking mechanism includes a locking gear, a locking bar, a spring, and a turning rod, wherein a hooked-shaped tip is provided in two front ends of said locking gear respectively for clasping the junction plates of said connection kit; a spring-loaded chamber is provided in the internal back end of said locking gear, and one end of the spring is firmly against the locking bar and; the axle center in the middle of said locking bar is provided for inserting a turning rod to control the onward and backward movement of said locking bar.

10. The extension ladder apparatus as claimed in claim 1, wherein the lower end of said hollow rung is provided with a sleeve-shaped buffering device, with its upper end hooked and affixed in the opening of said rung by means of a hooked-shaped portion, and the internal part of its lower end provided with an elastic seal ring to maintain friction when it contacts the internal part of said rung, and to reduce noise and slow down the folding.

11. The extension ladder apparatus as claimed in claim 10, wherein the inside of said buffering device is provided with a mylar with its surface having a hole for air circulation.
